(19) United States
(12) Patent Application Publication
(10) Pub. No.: US 2013/0021334 A1
(43) Pub. Date: Jan. 24, 2013

(54) LIQUID CRYSTAL DISPLAY

(71) Applicants: Jun Pyo LEE, Asan-si (KR); Se Huhn Hur, Yongin-si (KR); Bong Im Park, Asan-si (KR); Ik Hyun Ahn, Hwaseong-gi (KR); Kang-Min Kim, Seoul (KR); Jung-Won Kim, Seoul (KR)

(72) Inventors: Jun Pyo LEE, Asan-si (KR); Se Huhn Hur, Yongin-si (KR); Bong Im Park, Asan-si (KR); Ik Hyun Ahn, Hwaseong-gi (KR); Kang-Min Kim, Seoul (KR); Jung-Won Kim, Seoul (KR)

(73) Assignee: Samsung Display Co., Ltd., Yongin-City (JP)

(21) Appl. No.: 13/549,003

(22) Filed: Jul. 13, 2012

(30) Foreign Application Priority Data
Jul. 22, 2011 (KR) 10-2011-0073279

(51) Int. Cl. G06T 15/00; G09G 5/00

(52) U.S. Cl. 345/419; 345/204

(57) ABSTRACT

In a liquid crystal display, black data is input to a portion of the pixel rows only during display of a 3D image, the black data functioning as a black matrix. When a 2D image is displayed, the black data is replaced with color data. Thus, when displaying a 3D image, interference between a left image and a right image may be prevented without a reduction of the aperture ratio of the liquid crystal display during display of a 2D image.

### CROSS-REFERENCE TO RELATED APPLICATION

This application claims priority to and the benefit of Korean Patent Application No. 10-2011-0073279 filed on Jul. 22, 2011, which is hereby incorporated by reference for all purposes as if fully set forth herein.

### BACKGROUND

1. Field

Exemplary embodiments of the present invention relate to a liquid crystal display.

2. Discussion of the Background

A liquid crystal display (hereinafter referred to as an “LCD”) is one of the is most widely used flat panel displays. The LCD includes two display panels provided with electric field generating electrodes, such as pixel electrodes and a common electrode, and a liquid crystal layer interposed between the two display panels. In the LCD, voltages are applied to the electric field generating electrodes to generate an electric field in the liquid crystal layer. Due to the generated electric field, liquid crystal molecules of the liquid crystal layer are aligned and polarization of incident light is controlled, thereby displaying images.

Various techniques for realizing a 2D image and a 3D image have been developed for liquid crystal displays. Among them, in a case of a 3D display using a patterned retarder, a left image and a right image are alternately displayed for a pixel row of the display device of a spatial division type. Here, the left eye image is an image recognized by a left eye of a user, and the right image is an image recognized by a right eye of the user. In the case of a 3D display in which the left image and the right image are alternately displayed according to pixel row, the left image and the right image influence each other according to the position of the user.

To solve this problem, a black matrix extending in a row direction between a pixel row displaying the left image and a pixel row displaying the right image and having a wide width to reduce the interference of the image is formed.

However, the black matrix reduces the aperture ratio of the liquid crystal display, and the aperture ratio is decreased in the case of displaying a 2D image as well as the 3D image. Particularly, in a case of transverse pixels in which the pixels are formed in a direction of the pixel row, when forming a black matrix between the pixel rows, the entire resolution of the display device may be significantly decreased.

The above information disclosed in this Background section is only for enhancement of understanding of the background of the invention and therefore it may contain information that does not form the prior art that is already known to a person of ordinary skill in the art.

### SUMMARY OF THE INVENTION

Exemplary embodiments of the present invention provide a liquid crystal display that may prevent interference of a left image and a right image during display of a 3D image without a reduction of an aperture ratio in a case of displaying a 2D image.

Additional features of the invention will be set forth in the description which follows, and in part will be apparent from the description, or may be learned by practice of the invention.

An exemplary embodiment of the present invention discloses a liquid crystal display including a plurality of subpixels disposed in a row direction and a column direction, each pixel including a plurality of subpixels, wherein when displaying a 2D image, a color is displayed by a combination of a first subpixel, a second subpixel, and a third subpixel that are disposed in different subpixel rows among three adjacent subpixel rows and display different colors, and when displaying a 3D image, a color is displayed by a combination of two subpixels disposed in one subpixel row among two adjacent subpixel rows and onesub pixel disposed in the othersub pixel row among the two subpixel rows, and black data is input to a third subpixel row close to the two adjacent subpixel rows.

Three pixels disposed in the same pixel row and adjacent to each other may be the first pixel, the second pixel, and the third pixel displaying different colors.

Each pixel may have a longer length of an edge of a pixel row direction than the length of the edge of a pixel column direction.

The liquid crystal display may further include a signal controller, a 3D conversion unit connected to the signal controller, and a signal modifying unit disposed in the signal controller or the 3D conversion unit.

The signal modifying unit may input or output a signal only when displaying the 3D image.

An exemplary embodiment of the present invention also discloses a liquid crystal display including a plurality of pixels disposed in a row direction and a column direction, each pixel including a plurality of subpixels, wherein when displaying a 2D image, a color is displayed by a combination of a first subpixel, a second subpixel, a third subpixel, and a fourth subpixel that are disposed in differentsub pixel rows among four adjacent subpixel rows and display different colors, and when displaying a 3D image, a s color is displayed by a combination of the first subpixel, the second subpixel, and the third subpixel disposed in the three different subpixel rows among four adjacent subpixel rows and displaying different colors, and black data is input to the other subpixel row among the four subpixel rows.

The subpixels that are disposed in the same subpixel row and are adjacent to each other may display the same color.

According to the liquid crystal display according to an exemplary embodiment of the present invention, when only displaying a 3D image, black data is input to a portion of the subpixel rows, thereby functioning as a black matrix to prevent interference between a left image and a right image, and when displaying a 2D image, a is reduction of the aperture ratio of the liquid crystal display is prevented.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a liquid crystal display according to an exemplary embodiment of the present invention.

FIG. 2 is an equivalent circuit diagram of one pixel in a liquid crystal display according to an exemplary embodiment of the present invention.

FIG. 3 is a layout view of a pixel when displaying a 2D image of a liquid crystal display according to an exemplary embodiment of the present invention.

FIG. 4 is a layout view of a pixel when displaying a 3D image of a liquid crystal display according to an exemplary embodiment of the present invention.

FIG. 5 is a block diagram of a driver of a liquid crystal display according to an exemplary embodiment of the present invention.

FIG. 6 is a block diagram of a driver of a liquid crystal display according to another exemplary embodiment of the present invention.

FIG. 7 is a view of a portion of pixels in the liquid crystal display of FIG. 3.

FIG. 8 is a view of a portion of pixels in the liquid crystal display of FIG. 4.

FIG. 9 is a layout view of a pixel when displaying a 2D image of a liquid crystal display according to another exemplary embodiment of the present invention.

FIG. 10 is a layout view of a pixel when displaying a 3D image of a liquid crystal display according to another exemplary embodiment of the present invention.

### DETAILED DESCRIPTION OF THE ILLUSTRATED EMBODIMENTS

The present invention will be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art.

In the drawings, the thickness of layers, films, panels, regions, etc., are exaggerated for clarity. Like reference numerals designate like elements throughout the specification. It will be understood that when an element such as a layer, film, region, or substrate is referred to as being “on” or “connected to” another element, it can be directly on or directly connected to the other element or intervening elements may also be present. In contrast, when an element is referred to as being “directly on” or “directly connected to” another element, there are no intervening elements present. It will be understood that for purposes of this disclosure, “at least one of X, Y, and Z” can be construed as X only, Y only, Z only, or any combination of two or more items X, Y, and Z (e.g., XYZ, XYY, YZ, ZZ).

Now, a liquid crystal display according to an exemplary embodiment of the present invention will be described with reference to accompanying drawings.

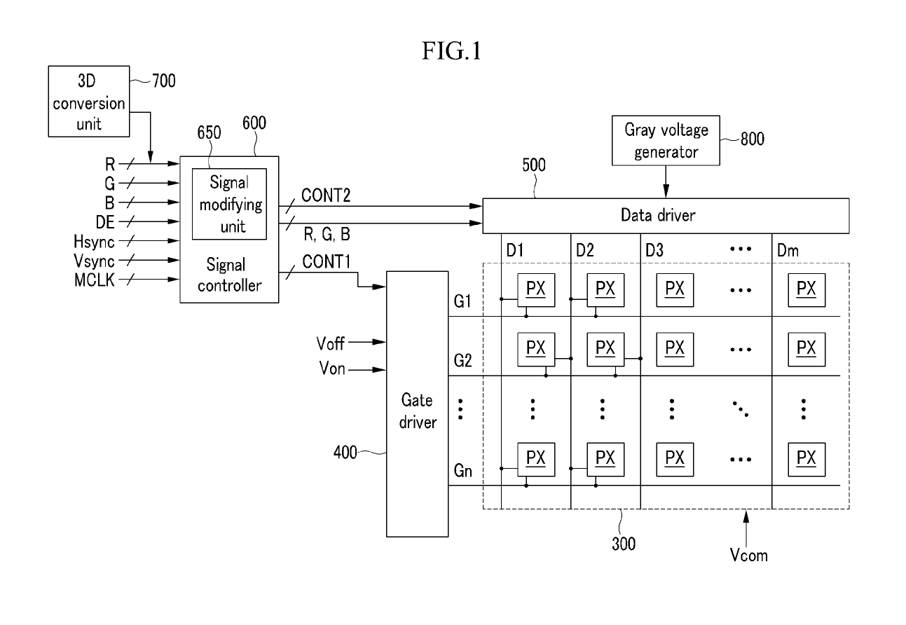

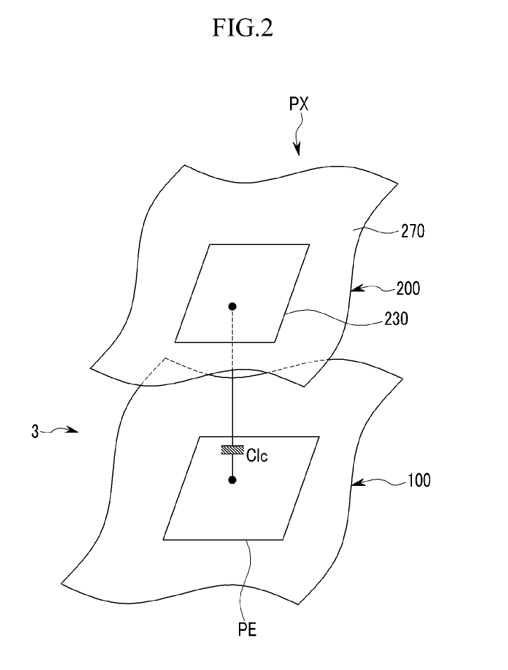

Firstly, a liquid crystal display according to an exemplary embodiment of the present invention will be described with reference to FIG. 1 and FIG. 2.

FIG. 1 is a block diagram of a liquid crystal display according to an exemplary embodiment of the present invention, and FIG. 2 is an equivalent circuit diagram of one pixel in a liquid crystal display according to an exemplary embodiment of the present invention.

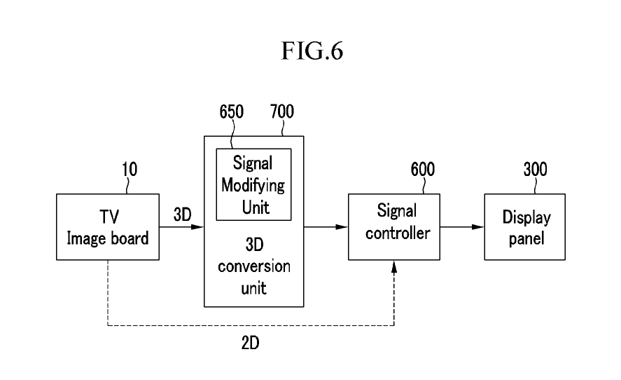

Referring to FIG. 1, a liquid crystal display according to an exemplary embodiment of the present invention includes a liquid crystal panel assembly 300, a gate driver 400, a data driver 500, a gray voltage generator 800, a signal controller 600, and a 3D conversion unit 700. The signal controller 600 includes a signal modifying unit 650. However, in a case of a liquid crystal display according to another exemplary embodiment of the present invention as shown in FIG. 6, the signal modifying unit 650 may be disposed in the 3D conversion unit 700.

Referring to FIG. 1, in an equivalent circuit of the liquid crystal panel assembly 300, the liquid crystal panel assembly 300 includes a plurality of signal lines G1-Gn and D1-Dm, and a plurality of pixels PX arranged in an approximate matrix. In a structure shown in FIG. 2, the liquid crystal panel assembly 300 includes a lower panel 100 and an upper panel 200 facing each other, and a liquid crystal layer 3 interposed therebetween.

The signal lines G1-Gn and D1-Dm include a plurality of gate lines G1 to Gn for transmitting gate signals (referred to as “scanning signals”), and a plurality of data lines D1 to Dm for transmitting a data voltage. The gate lines G1 to Gn are arranged in parallel to each other and extend approximately in a row direction, and the data lines D1 to Dm are arranged in parallel to each other and extend approximately in a column direction.

Each pixel PX, for example a pixel PX that is connected to an i-th (i=1, 2, . . . , n) gate line Gi and a j-th (j=1, 2, . . . , m) data line Dj includes a switching element that is connected to the signal lines Gi and Dj, and a liquid crystal capacitor Clc and a storage capacitor Cst (not shown) that are connected thereto. The storage capacitor Cst may be omitted.

The switching element may be a three terminal element such as a thin film transistor provided on the lower panel 100, and a control terminal thereof is connected to the gate line Gi, an input terminal thereof is connected to the data line Dj, and an output terminal thereof is connected to the liquid crystal capacitor Clc and the storage capacitor Cst.

The liquid crystal capacitor Clc has two terminals of a pixel electrode PE of the lower panel 100 and a common electrode 270 of the upper panel 200. The liquid crystal layer 3 between the pixel and common electrodes PE and 270 serves as a dielectric material. The pixel electrode PE is connected to the switching element, and the common electrode 270 is formed on the whole surface of the upper panel 200 and receives a common voltage Vcom. Although different from what is shown in FIG. 2, the common electrode 270 may be formed on the lower panel 100, and at least one of the pixel and common electrodes PE and 270 may have a linear shape or a bar shape.

The storage capacitor Cst that serves as an auxiliary to the liquid crystal capacitor Clc is formed as a separate signal line (not shown) provided on the lower panel 100 and the pixel electrode PE overlapping it with an insulator interposed therebetween, and a predetermined voltage such as a common voltage Vcom or the like is applied to the separate signal line. However, the storage capacitor Cst may be formed by the pixel electrode PE and the overlying previous gate line Gi-1 that are arranged to overlap each other via the insulator.

For color display, each pixel PX may uniquely represent one of primary colors (i.e., spatial division) or each pixel PX may sequentially represent the primary colors in turn (i.e., temporal division), such that a spatial or temporal sum of the primary colors is recognized as a desired color. An example of a set of the primary colors includes red, green, and blue. FIG. 2 shows an example of the spatial division in which each pixel PX includes a color filter 230 representing one of the primary colors in an area of the lower panel 100 corresponding to the pixel electrode PE. The color filter 230 may be made of an organic insulator.

At least one polarizer (not shown) for providing light polarization is provided in the liquid crystal panel assembly 300.

Also, a patterned retarder is provided in the liquid crystal panel assembly 300. The patterned retarder may be formed on the insulation substrate and may be formed on the liquid crystal panel assembly 300 as a film type.

Now, a driver of a liquid crystal display according to an exemplary embodiment of the present invention will be described.

Referring again to FIG. 1, the gray voltage generator 800 generates all gray voltages or a predetermined number of gray voltages (or reference gray voltages) related to transmittance of the pixels PX. The gray voltages may include one set having a positive is value for a common voltage Vcom, and another set having a negative value.

The gate driver 400 is connected to the gate lines G1 to Gn of the liquid crystal panel assembly 300, and applies gate signals obtained by combining a gate-on voltage Von and a gate-off voltage Voff to the gate lines G1 to Gn.

The data driver 500 is connected to the data lines D1 to Dm of the liquid crystal panel assembly 300, and selects the gray voltages from the gray voltage generator 800 to apply them to the data lines D1-Dm as data voltages. However, when the gray voltage generator 800 does not supply a voltage for all grays but supplies only a predetermined number of reference gray voltages, the data driver 500 divides the reference gray voltages to generate the data voltages.

The signal controller 600 controls the gate driver 400 and the data driver 500. The signal controller 600 includes the signal modifying unit 650.

The 3D conversion unit 700 converts the image signal into a 3D signal when s displaying the 3D image and inputs it to the signal controller 600. The 3D image includes a left image and a right image that are alternately output in a pixel column direction.

Each of the drivers 400, 500, 600, 700, and 800 may be directly mounted on the liquid crystal panel assembly 300 in the form of at least one IC chip; may be mounted on a flexible printed circuit film (not shown) and then mounted on the liquid crystal panel assembly 300 in the form of a tape carrier package (TCP); or may be mounted on a separate printed circuit board (not shown). Alternatively, the drivers 400, 500, 600, and 800 may be integrated with the liquid crystal panel assembly 300 together with, for example, the signal lines G1-Gn and D1-Dm and the thin film transistor switching element. The drivers 400, 500, 600, and 800 may be integrated into a single chip. In this case, at least one of the is drivers or at least one circuit forming the drivers may be arranged outside the single chip.

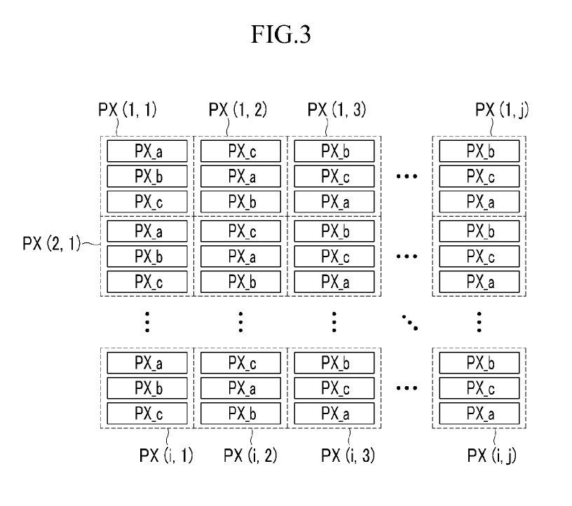

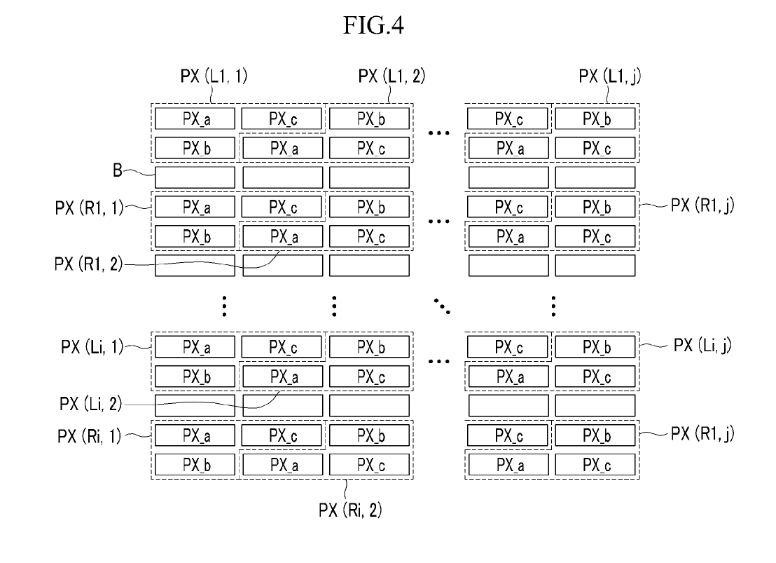

Now, a pixel arrangement of a liquid crystal display according to an exemplary embodiment of the present invention will be described with reference to FIG. 3 and FIG. 4. FIG. 3 is a layout view of a pixel when displaying a 2D image of a liquid crystal display according an exemplary embodiment of the present invention, and FIG. 4 is a layout view of a pixel when displaying a 3D image of a liquid crystal display according an exemplary embodiment of the present invention.

Referring to FIG. 3 and FIG. 4, each pixel PX of the liquid crystal display according to the present exemplary embodiment includes a first subpixel PX_a displaying a first color, a second subpixel PX_b displaying a second color, and a third subpixel PX_c displaying a third color.

Firstly, referring to FIG. 3, the arrangement of the pixels will be described in a case that the liquid crystal display according to the present exemplary embodiment s displays the 2D image.

The first pixel PX (1, 1) including three subpixels firstly disposed at three subpixel rows has the first subpixel PX_a, the second subpixel PX_b, and the third subpixel PX_c that are sequentially disposed in the pixel column direction. The second pixel PX (1, 2) neighboring the first pixel PX (1, 1) in the pixel row direction has the third subpixel PX_c, the first subpixel PX_a, and the second subpixel PX_b that are sequentially disposed in the pixel column direction. The third pixel PX (1, 3) neighboring the second pixel PX (1, 2) in the pixel row direction has the second subpixel PX_b, the third subpixel PX_c, and the first subpixel PX_a that are sequentially disposed in the pixel column direction.

This pixel arrangement is repeated in the pixel row direction and the pixel is column direction.

According to this arrangement, the fourth pixel PX (i, 1) including three subpixels disposed at three subpixel rows also has the first subpixel PX_a, the second subpixel PX_b, and the third subpixel PX_c that are sequentially disposed in the pixel column direction, the fifth pixel PX (i, 2) neighboring the fourth pixel PX (i, 1) in the pixel row direction also has the third subpixel PX_c, the first subpixel PX_a, and the second subpixel PX_b that are sequentially disposed in the pixel column direction, and the sixth pixel PX (i, 3) neighboring the fifth pixel PX (i, 2) in the pixel row direction has the second subpixel PX_b, the third subpixel PX_c, and the first subpixel PX_a sequentially disposed in the pixel column direction.

Also, the pixels PX (1, j), . . . , PX (i, j) each including three subpixels disposed in three subpixel rows and disposed in the final pixel column have the second subpixel PX_b, the third subpixel PX_c, and the first subpixel PX_a sequentially disposed s in the pixel column direction.

Each pixel displays the desired color at a desired luminance by the sum of the first subpixel PX_a, the second subpixel PX_b, and the third subpixel PX_c.

As shown, each subpixel of the liquid crystal display according to the present exemplary embodiment has a longer length of the edge extending in the pixel row direction than the length of the edge extending in the pixel column direction.

In this way, the liquid crystal display according to the present exemplary embodiment includes three subpixels sequentially disposed in the pixel column direction and displaying the different colors, and the arrangement sequence of the three subpixels is different from in the neighboring pixel columns. In detail, three subpixels disposed in the is same subpixel row and neighboring each other may display different colors. When the liquid crystal display displays the 2D image, each pixel displays the desired color of a desired luminance by the sum of the three subpixels.

Next, referring to FIG. 4, the arrangement of the pixels when the liquid crystal display according to the present exemplary embodiment displays the 3D image will be described.

The first pixel PX (L1, 1) including subpixels disposed in the first subpixel row and the second subpixel row displays the left image, and has the first subpixel PX_a and the third subpixel PX_c disposed in the first subpixel row, and the second subpixel PX_b disposed in the second subpixel row. Also, the second pixel PX (L1, 2) adjacent to the first pixel PX (L1, 1) in the pixel row direction displays the left image and has the second subpixel PX_b disposed in the first subpixel row, and the first subpixel PX_a and the third subpixel PX_c disposed in the second subpixel row.

The pixel (B) disposed in the third subpixel row disposed next to the second subpixel row is input with black data, thereby displaying black. The subpixel row for displaying black displays a color when the liquid crystal display displays the 2D image, however the subpixel row displays black when displaying the 3D image such that interference between the left image and the right image adjacent to each other in the pixel column direction according to the position of the user may be prevented.

Similarly, the third pixel PX (R1, 1) including subpixels disposed in the fourth subpixel row and the fifth subpixel row displays the right image and has the first subpixel PX_a and the third subpixel PX_c disposed in the fourth subpixel row, and the second subpixel PX_b disposed in the fifth subpixel row. Also, the fourth pixel PX (R1, 2) is adjacent to the third pixel PX (R1, 1) in the pixel row direction displays the right image and has the second subpixel PX_b disposed in the fourth subpixel row, and the first subpixel PX_a and the third subpixel PX_c disposed in the fifth subpixel row.

The pixel (B) disposed in the sixth subpixel row disposed next to the fifth subpixel row is input with black data, thereby displaying black. The subpixel row for displaying black displays a color when the liquid crystal display displays the 2D image, however the subpixel row displays black when displaying the 3D image such that the interference between the left image and the right image adjacent to each other in the pixel column direction according to the position of the user may be prevented.

This arrangement is repeated in the pixel row and pixel column directions.

According to this arrangement, the fifth pixel PX (Li, 1) including subpixels disposed in two adjacent subpixel rows also displays the left image and has the first subpixel PX_a and the third subpixel PX_c disposed in the seventh subpixel row, and the second subpixel PX_b disposed in the eighth subpixel row. Also, the sixth pixel PX (Li, 2) adjacent to the fifth pixel PX (L1, 1) in the pixel row direction displays the left image and has the second subpixel PX_b disposed in the seventh subpixel row, and the first subpixel PX_a and the third subpixel PX_c disposed in the eighth subpixel row.

The pixel (B) disposed in the ninth subpixel row disposed next to the eighth subpixel row is input with black data, thereby displaying black. The subpixel row for displaying the black displays a color when the liquid crystal display displays the 2D image, however the subpixel row displays black when displaying the 3D image such that the interference between the left image and the right image adjacent to each other in the pixel column direction according to the position of the user may be prevented.

Similarly, the seventh pixel PX (Ri, 1) including subpixels disposed in two subpixel rows disposed next to the ninth subpixel row displays the right image and has the first subpixel PX_a and the third subpixel PX_c disposed in the tenth subpixel row, and the second subpixel PX_b disposed in the eleventh subpixel row. Also, the eighth pixel PX (Ri, 2) adjacent to the seventh pixel PX (Ri, 1) in the subpixel row direction displays the right image and has the second subpixel PX_b disposed in the tenth subpixel row, and the first subpixel PX_a and the third subpixel PX_c disposed in the eleventh subpixel row.

As shown in FIG. 3, the fifth pixel PX (i, 2) adjacent to the fourth pixel PX (i, 1) in the pixel row direction includes the third subpixel PX_c, the first subpixel PX_a, the second subpixel PX_b sequentially disposed in the pixel column direction, and the sixth pixel PX (i, 3) neighboring the fifth pixel PX (i, 2) in the pixel row direction includes the second subpixel PX_b, the third subpixel PX_c, and the first subpixel PX_a sequentially disposed in the pixel column direction.

The pixels PX (1, j), ..., PX (i, j) including three subpixels disposed in three subpixel rows and disposed in the final pixel column include the second subpixel PX_b, the third subpixel PX_c, and the first subpixel PX_a sequentially disposed in the pixel column direction.

Each pixel displays a desired color of a desired luminance by the sum of the first subpixel PX_a, the second subpixel PX_b, and the third subpixel PX_c.

As shown in FIG. 4, the pixel of the liquid crystal display according to the present exemplary embodiment has a longer length of the edge extending in the pixel row direction than the length of the edge extending in the pixel column direction.

In this way, when displaying the 3D image, each pixel includes two subpixels is disposed in one of two neighboring subpixel rows and one subpixel disposed in the other subpixel row, and displays the desired color of the desired luminance by the combination of the subpixels. Also, the pixel (B) disposed in one subpixel row adjacent to two subpixel rows displaying the desired image is input with the black data, thereby displaying black. The subpixel row displaying black displays a color when the liquid crystal display displays the 2D image, however the subpixel row displays black when displaying the 3D image such that the interference between the images of the pixels adjacent to each other in the pixel column direction according to the position of the user may be prevented.

As described above, in the liquid crystal display according to an exemplary embodiment of the present invention, an additional black matrix having a long width in the pixel column direction is not formed between the pixel displaying the left image of the 3D image and the pixel displaying the right image in the liquid crystal display, the desired color is displayed when displaying the 2D image, and the black data is input to a portion of the subpixel rows when displaying the 3D image, and thereby the interference between the images between the pixels neighboring in the pixel column direction according to the position of the user may be prevented without the reduction of the aperture ratio of the liquid crystal display. Particularly, when displaying the 2D image, neither the resolution nor the aperture ratio is decreased.

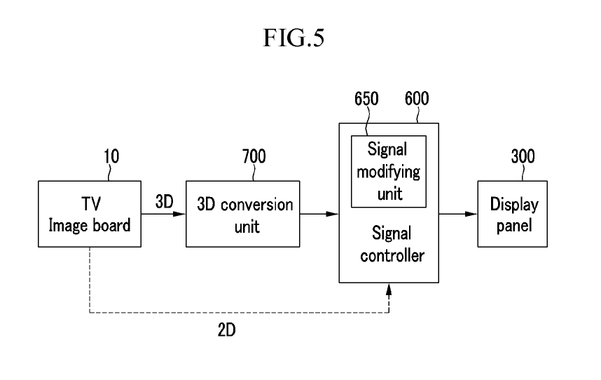

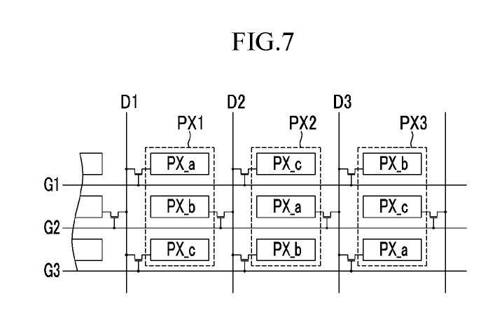

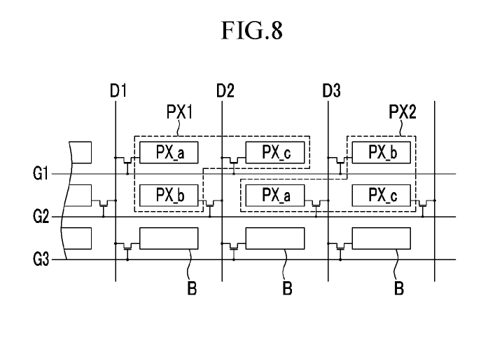

Next, a driving method of a liquid crystal display according to an exemplary embodiment of the present invention will be described with reference to FIG. 5 to FIG. 8. FIG. 5 is a block diagram of a driver of a liquid crystal display according to an exemplary embodiment of the present invention, FIG. 6 is a block diagram of a driver of a liquid crystal display according to another exemplary embodiment of the present invention, FIG. 7 is a view of a portion of pixels in the liquid crystal display of FIG. 3, and FIG. 8 is a view of a portion of pixels in the liquid crystal display of FIG. 4.

Firstly, a driver of a liquid crystal display according to different exemplary embodiments of the present invention will be described with reference to FIG. 5 and FIG. 6.

Referring to FIG. 5, a driver of a liquid crystal display according to an exemplary embodiment of the present invention includes a TV image board 10 and the 3D conversion unit 700, and the signal controller 600 connected to the display panel 300. The liquid crystal display according to the present exemplary embodiment includes the signal modifying unit 650 in the signal controller 600.

Referring to FIG. 6, the driver of the liquid crystal display according to another exemplary embodiment of the present invention includes the TV image board 10 and the 3D conversion unit 700, and the signal controller 600 connected to the display panel 300, but differently from the exemplary embodiment shown in FIG. 5, the signal modifying unit 650 is disposed in the 3D conversion unit 700.

Referring to FIG. 7 along with FIG. 5 and FIG. 6, the driving method to display the 2D image of the liquid crystal display according to an exemplary embodiment of the present invention will be described.

When displaying the 2D image, if the image signal is output from the TV image board 10, the image signal is input to the signal controller 600 and a gate signal and a data signal are input to the display panel 300 according to the operation of the signal controller 600. In detail, referring to FIG. 7, if the first gate line G1 is input with the gate-on signal, a predetermined data signal is input to the first subpixel PX_a of the first pixel PX1 through the first data line D1, a predetermined data signal is input to the third subpixel PX_c of the second pixel PX2 through the second data line D2, and a predetermined data signal is input to the second subpixel PX_b of the third pixel PX3 through the third data line D3.

Next, the second gate line G2 is input with the gate on signal, the predetermined data signal is input to the second subpixel PX_b of the first pixel PX1 through the second data line D2, and the predetermined data signal is input to the first subpixel PX_a of the second pixel PX2 through the third data line D3.

According to the driving method, each pixel displays the desired luminance and the desired color according to the data voltage input to the three subpixel electrodes disposed in three pixel columns neighboring each other in the column direction.

In this way, when displaying the 2D image, the image signal is not input and output to and from the 3D conversion unit 700 and the signal modifying unit 650 of the liquid crystal display, but bypasses them, and thereby the signal to display the image is input s to the display panel 300.

Next, referring to FIG. 8 along with FIG. 5 and FIG. 6, the driving method to display the 3D image of the liquid crystal display according to an exemplary embodiment of the present invention will be described.

When displaying the 3D image, if the image signal is output from the TV image board 10, the image signal is input to the 3D conversion unit 700 and is converted into the left image and the right image for the 3D image. Next, the converted image signal is down scaled to 2/3 in the signal modifying unit 650 compared with the 2D image signal, and the image signal to be input to each subpixel is mapped with a desired position. Through the down scaling and the mapping of the signal modifying unit 650, the desired is signal is output to the desired subpixel area.

In detail, referring to FIG. 8, the desired data voltage is applied to two subpixels PX_a and PX_c disposed in the first subpixel row among two subpixel rows connected to the first and second gate lines G1 and G2 adjacent to each other and one subpixel PX_b disposed in the second subpixel row, and thereby the image of the desired luminance and the desired color is displayed to the first pixel PX1, while the data voltage is applied to one subpixel PX_b disposed in the first subpixel row and two subpixels PX_a and PX_c disposed in the second subpixel row, and thereby the image of the desired luminance and the desired color is displayed to the second pixel PX2. Also, when the gate-on signal is applied to the third gate line G3 neighboring the second gate line G2, all data lines D1, D2, D3, . . . are applied with the black data voltage, and thereby all subpixels disposed in the third subpixel row connected to the third gate line G3 display black.

In this way, the liquid crystal display according to an exemplary embodiment s of the present invention maps the image of each pixel input in the 3D conversion unit 700 and the signal modifying unit 650 at a desired position, and thereby the image having the desired luminance and the desired color may be displayed at the desired position. Also, when only displaying the 3D image, the black data is input to the entire subpixel row disposed between the subpixel row displaying the left image and the subpixel row displaying the right image such that the interference between the left image and the right image may be prevented without an additional black matrix, and thereby the aperture ratio of the liquid crystal display and the resolution of the 2D image may not be reduced.

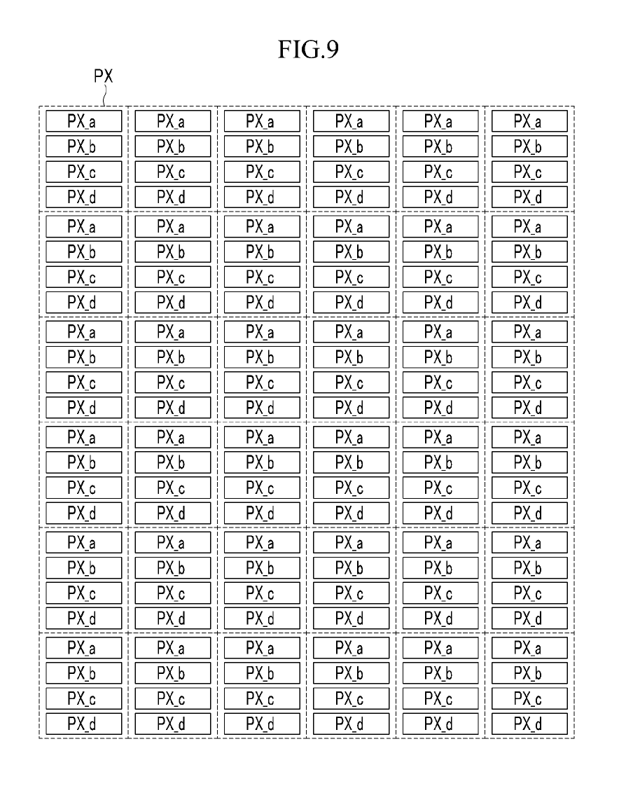

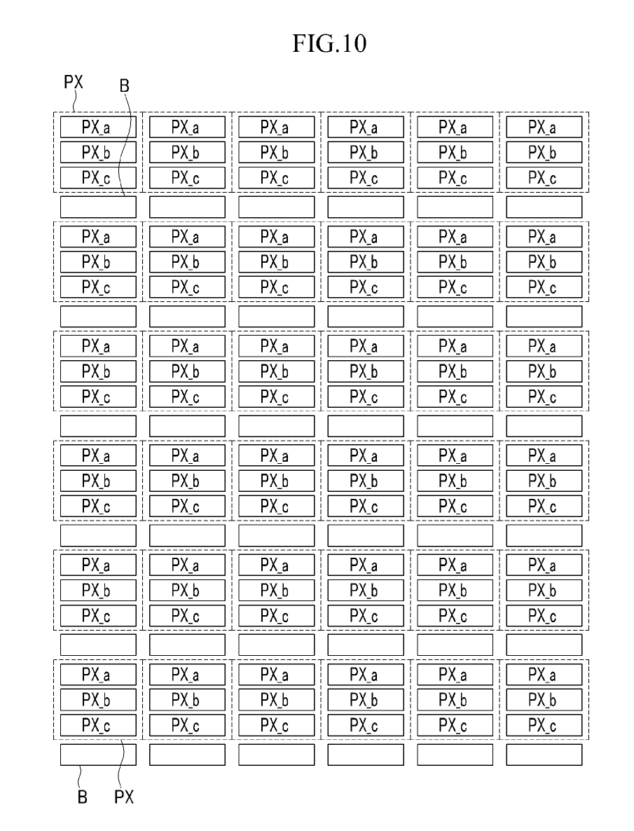

A pixel arrangement of a liquid crystal display according to another exemplary embodiment of the present invention will be described with reference to FIG. 9 is and FIG. 10. FIG. 9 is a layout view of pixels when displaying a 2D image of a liquid crystal display according to another exemplary embodiment of the present invention, and FIG. 10 is a layout view of pixels when displaying a 3D image of a liquid crystal display according to another exemplary embodiment of the present invention.

Referring to FIG. 9, each pixel PX includes the first subpixel PX_a, the second subpixel PX_b, the third subpixel PX_c, and the fourth subpixel PX_d that are sequentially disposed in the pixel array direction and display different colors.

When displaying the 2D image, a predetermined data voltage is applied to the first subpixel PX_a, the second subpixel PX_b, the third subpixel PX_c, and the fourth subpixel PX_d, and the desired luminance and desired color may be displayed by the combination of the first subpixel PX_a, the second subpixel PX_b, the third subpixel PX_c, and the fourth subpixel PX_d.

Referring to FIG. 10, each pixel PX includes the first subpixel PX_a, the second subpixel PX_b, and the third subpixel PX_c that are sequentially disposed in the pixel array direction and display different colors.

The black data is input to the entire subpixel row between the third subpixel PX_c of the pixel PX and the first subpixel PX_a of the pixel PX that are adjacent to each other in the pixel column direction. Accordingly, when displaying the 3D image, the desired luminance and the desired color may be displayed by the combination of the first subpixel PX_a, the second subpixel PX_b, and the third subpixel PX_c.

The pixel B input with the black data may prevent the interference between the images between the pixels adjacent in the pixel column direction according to the position of the user.

Differently from the exemplary embodiment shown in FIG. 3 and FIG. 4, the arrangement of the subpixels of the liquid crystal display according to the exemplary embodiment shown in FIG. 9 and FIG. 10 may be constant. Also, in the case of the display device according to the present exemplary embodiment, the number of pixels displaying the 2D image may be equal to the number of pixels displaying the 3D image. However, when displaying the 2D image, each pixel displays the image by the combination of four subpixels, but when displaying the 3D image, each pixel displays the image by the combination of three subpixels.

As described above, according to the liquid crystal display according to an exemplary embodiment of the present invention, when only displaying the 3D image, the black data is input to the portion of the subpixel rows, thereby functioning as the black matrix, and when displaying the 2D image, the interference between the left image and the right image may be prevented without the reduction of the aperture ratio of the liquid crystal display.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display, comprising:
a plurality of subpixels disposed in a row direction and a column direction,
wherein when displaying a 2D image, a color is displayed by a combination of a first subpixel, a second subpixel, and a third subpixel that are disposed in different subpixel rows among three adjacent subpixel rows and respectively display different colors, and
when displaying a 3D image, the 3D image is displayed by a combination of two subpixels disposed in one subpixel row among two adjacent subpixel rows and one subpixel disposed in the other subpixel row among the two subpixel rows, and black data is input to a third subpixel row close to the two adjacent subpixel rows.

2. The liquid crystal display of claim 1, wherein
three subpixels disposed in the same subpixel row and adjacent to each other are the first subpixel, the second subpixel, and the third subpixel, each displaying different colors.

3. The liquid crystal display of claim 1, wherein
each subpixel has a longer length of an edge of a pixel row direction than the length of the edge of a pixel column direction.

4. The liquid crystal display of claim 1, further comprising:
a signal controller;
a 3D conversion unit connected to the signal controller; and
a signal modifying unit disposed in either the signal controller or the 3D conversion unit.

5. The liquid crystal display of claim 4, wherein
the signal modifying unit inputs or outputs a signal only when displaying the 3D image.

6. A liquid crystal display, comprising:
a plurality of subpixels disposed in a row direction and a column direction,
wherein when displaying a 2D image, a color is displayed by a combination of a first subpixel, a second subpixel, a third subpixel, and a fourth subpixel that are disposed in different subpixel rows among four adjacent subpixel rows and respectively display different colors, and when displaying a 3D image, the image is displayed by a combination of the first subpixel, the second subpixel, and the third subpixel disposed in three different subpixel rows among four adjacent subpixel rows and respectively displaying different colors, and black data is input to the other subpixel row among the four subpixel rows.

7. The liquid crystal display of claim 6, wherein
the subpixels that are disposed in the same subpixel row and are adjacent to each other display the same color.

8. The liquid crystal display of claim 6, wherein
each subpixel has a longer length of an edge of a pixel row direction than the length of the edge of a pixel column direction.

9. The liquid crystal display of claim 6, further comprising:
a signal controller;
a 3D conversion unit connected to the signal controller; and
a signal modifying unit disposed in either the signal controller or the 3D conversion unit.

10. The liquid crystal display of claim 9, wherein
the signal modifying unit inputs or outputs a signal only when displaying the 3D image.

11. A liquid crystal display, comprising:
a signal controller; and
a first pixel, a second pixel, and a third pixel, each of the first pixel, the second pixel, and the third pixel comprising n subpixels, n being an integer of at least 3,
wherein in a first image display mode, the signal controller is configured to drive the n subpixels of the first pixel together to display a first image, the n subpixels of the second pixel together to display a second image, and the n subpixels of the third pixel together to display a third image,
wherein in a second image display mode, the signal controller is configured to drive (n−x) subpixels of the first pixel and (n−y) subpixel(s) of the second pixel together to display a fourth image, (n−y) subpixel(s) of the second pixel and (n−x) subpixels of the third pixel together to display a fifth image, and one subpixel of the first pixel, one subpixel of the second pixel, and one subpixel of the third pixel to display a black color, and
wherein n is a natural number of 3 or more, x and y are natural numbers, and x+y=n.

12. The liquid crystal display of claim 11, wherein the first image display mode is a two dimensional image display mode, and the second image display mode is a three dimensional image display mode.

13. The liquid crystal display of claim 12, wherein n=3, x=1, and y=2.

14. The liquid crystal display of claim 13, wherein the one subpixel of the first pixel, the one subpixel of the second pixel, and the one subpixel of the third pixel used to display the black color are all disposed in the same subpixel row.
